(19) United States
(12) Patent Application Publication
(10) Pub. No.: US 2007/0137585 A1
(43) Pub. Date: Jun. 21, 2007

(54) Animal feeder

(76) Inventors: Andrew J. Rausch, Rochester, IN (US); Harry R. Van Horn II, Monterey, IN (US)

Correspondence Address: HARNESS, DICKEY & PIERCE, P.L.C., P.O. BOX 828, BLOOMFIELD HILLS, MI, 48303, US

(21) Appl. No.: 11/545,035

(22) Filed: Oct. 6, 2006

Related U.S. Application Data
(60) Provisional application No. 60/725,513, filed on Oct. 10, 2005.

(51) Int. Cl. A01K 5/00

(52) U.S. Cl. 119/53

(57) ABSTRACT

A feed hopper is located above a feed pan to dispense feed by gravity flow into the feed pan. Partitions divide the animal feeder to accommodate multiple animals simultaneously. A user adjustable feed gate controls the feed portion and rate of feed dispensed and animal actuated mechanical agitators ensure the entire feed portion is received. The animal feeder contains a watering system to deliver water and feed, either mixing water and feed or keeping them separate, while the animal is using the feeder. The side wall of the feed pan is adjustable in vertical and horizontal dimensions between a raised position and a lowered position. Thus, the feeder can accommodate animals of different sizes or animals throughout growth stages.

### CROSS-REFERENCE TO RELATED APPLICATIONS

This application claims the benefit of U.S. Provisional Application No. 60/725,513, filed on Oct. 10, 2005. The disclosure of the above application is incorporated herein by reference.

### FIELD

The present invention relates to animal feeders, and more specifically, to the feed pans or feed troughs of a gravity-flow animal feeder.

### INTRODUCTION AND BACKGROUND

Animal and livestock feeders can typically be gravity flow type feeders, with a raised hopper or feed reservoir leading to a feed pan, or dispensing feed to a plurality of feed pans. The feed pans are sometimes shaped into the form of a feed trough. In addition, some feed pans can be separated into various feeding stations by partitioning bars or panel dividers. Previous feed pans were typically rigid structures that included generally upwardly extending side walls to contain the feed within the feed pan.

One problem with such rigid feed pans is the difficulty in satisfactorily accommodating both larger and smaller animals. Larger animals are taller and tend to require larger quantities of feed in the feed pan. In addition, one concern with larger animals is their tendency to cause the feed to spill from the feed pan. Thus, for larger animals, there is a desire to have a feed pan that is relatively high, large and deep. Smaller animals, on the other hand, tend to be shorter and require smaller quantities of feed in the feed pan. In addition, one concern for smaller animals is their ability to access the feed in the feed pan and/or to access any animal actuation mechanisms of the feeder. Thus, for smaller animals, there is a desire to have a feed pan that is relatively low, small and shallow. Consequently, problems arise when an animal feeder is used to feed different groups of animals where each group is a different size or at different growth stages or to feed the same group as it progresses through different sizes and growth stages.

### SUMMARY

In one aspect of the disclosure an animal feeder is provided. The animal feeder includes a feed pan having a movable side wall that extends generally upwardly and over which an animal accesses feed in the feed pan. The moveable side wall is moveable between a raised position and a lowered position.

In another aspect of the disclosure an animal feeder is provided. The animal feeder includes a feed hopper and a feed pan comprising a moveable side wall and a pair of opposing end walls. The movable side wall defines an animal feed access opening. An adjustable feed gate between the feed hopper and the feed pan controls the flow of feed from the feed hopper to the feed pan. A guide is adjacent each of the pair of opposing end walls. Each guide supports an opposing end portion of the moveable side wall for movement along the guides. The guides are angled with respect to a vertical orientation.

In another aspect of the disclosure an animal feeder includes a feed hopper and a feed pan located below the feed hopper to receive feed from the feed hopper. The feed pan includes a fixed pan extension and a movable pan extension supported adjacent the fixed pan extension in a guide. A crank assembly is operably connected to the movable pan extension to move the movable pan extension along the guide to change a position of the movable pan extension in both a vertical dimension and a lateral dimension.

Further areas of applicability of the present embodiments will become apparent from the detailed description provided hereinafter. It should be understood that the detailed description and specific examples, while indicating various embodiments, are intended for purposes of illustration only and are not intended to limit the scope of the invention.

It should be understood that the headings (such as “Introduction” and “Summary,”) used herein are intended only for general organization of topics within the disclosure of the invention, and are not intended to limit the disclosure of the invention or any aspect thereof. In particular, subject matter disclosed in the “Introduction” may include aspects of technology within the scope of the invention, and may not constitute a recitation of prior art. Subject matter disclosed in the “Summary” is not an exhaustive or complete disclosure of the entire scope of the invention or any embodiments thereof.

### DESCRIPTION OF THE DRAWINGS

The present embodiments will become more fully understood from the detailed description and the accompanying drawings, wherein:

FIG. 1 is a perspective view of an animal feeder according to an aspect of the embodiments with a feed pan extension in the raised position;

FIG. 2 is a perspective view of an animal feeder according to an aspect of the embodiments with a feed pan extension in the lowered position;

FIG. 3 is a side, cross-sectional view of an animal feeder according to an aspect of the embodiments;

FIG. 4 is a top, cross-sectional view of an animal feeder according to an aspect of the embodiments, showing two bird assemblies and two shaker assemblies within the feed hopper; and

FIG. 5 is a front view of an animal feeder according to an aspect of the embodiments, with a cut-out showing a paddle assembly and pivot linking to a bird assembly and a shaker assembly.

### DESCRIPTION

The following description and specific embodiments are intended for purposes of illustration only and are not intended to limit the invention, its application, or uses. Moreover, recitation of the embodiments having specifically stated features is not intended to exclude other embodiments having additional features, or other embodiments incorporating different combinations of the stated features, or even embodiments lacking a specifically stated feature. Specific aspects of embodiments are provided for illustrative purposes of how to make, use, and practice the invention and, unless explicitly stated otherwise, are not intended to be a representation that given embodiments of this invention have, or have not, been made or tested.

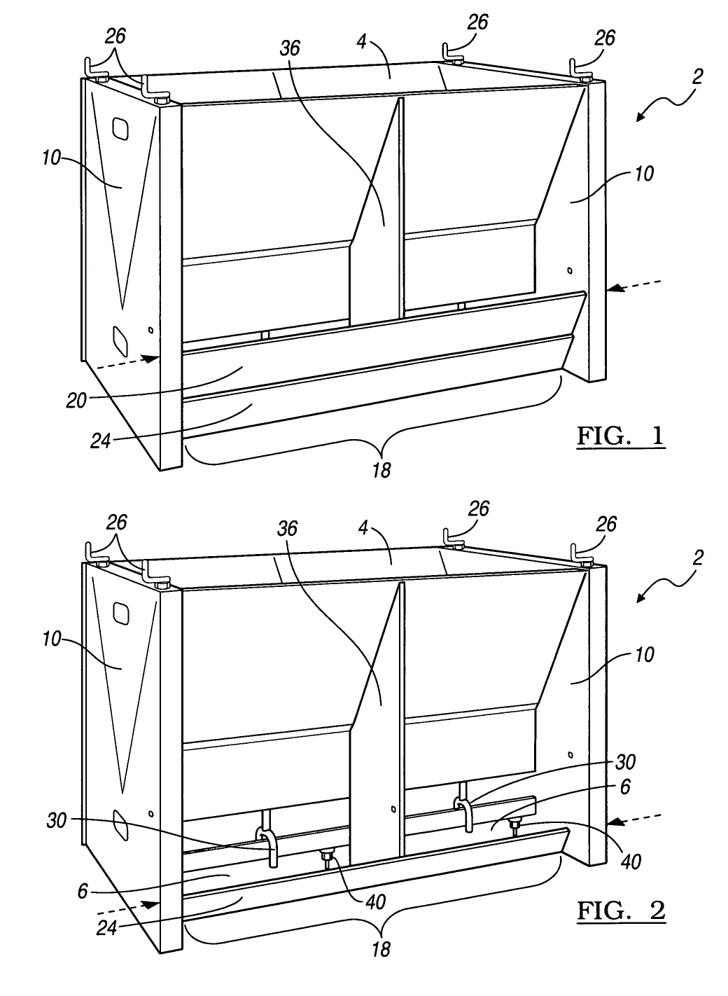

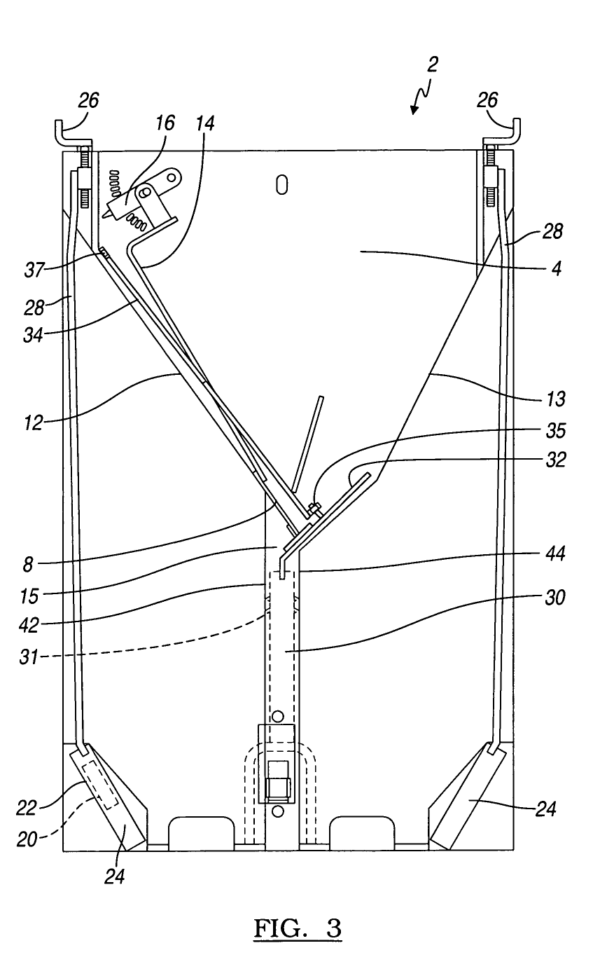

Referring to FIGS. 1 and 2, an animal feeder 2 can include a feed hopper 4, a feed pan 6, and a feed gate 8 (seen in FIG. 3) between the feed hopper 4 and the feed pan 6. The feed hopper 4 is typically a raised reservoir with an opening at the top into which feed can be poured to fill the feed hopper 4. Feed can be dispensed into the feed pan 6 from the hopper 4 by gravity flow, due to its elevated position relative to the feed pan 6. When the animal feeder 2 is viewed from the top, the feed hopper 4 is typically elongated and rectangular in shape. In this embodiment, the shorter sides of the rectangle of the feed hopper 4 are defined by the closed end walls 10 of the animal feeder 2. The end walls 10 of the hopper 4 also form the end walls 10 of the feed pan 6. These end walls 10 are typically substantially vertical and rectangular in shape. The longer sides of the rectangle of the feed hopper 4 are associated with the sides along which animals access the feeder. This long dimension of the rectangular feed hopper 4 defines the bottom thereof.

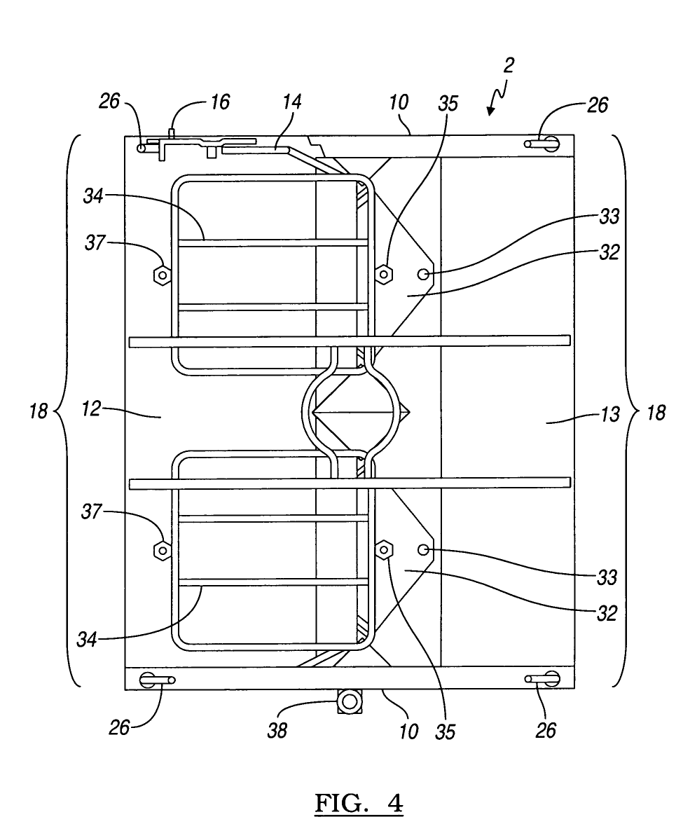

Referring to FIGS. 3 and 4, the bottom of the feed hopper can be formed by two walls 12, 13 which converge downwardly toward the feed gate 8. Viewed from an end side of the animal feeder 2, these downwardly converging walls 12, 13 of the feed hopper 4 form a funnel shape, with the feed gate 8 disposed within the throat of the funnel. Each of the sheet panels forming the downwardly converging walls 12, 13 can be bent to form a vertically extending wall 42 and 44, respectively, to provide a feed channel 15 between the feed hopper 4 and the feed pan 6. The feed gate 8 can be mechanically connected to a feed gate rod assembly 14 that runs upwardly to the top of the animal feeder 2 and pivotably connected to a lever assembly 16. The lever assembly 16 can be pivoted to move in an arc to adjust the position of the feed gate 8, between a fully open position and a fully closed position, and includes various intermediate positions therebetween. Consequently, the feed gate 8 can be adjusted to control the flow rate by which feed is dispensed and/or the total amount of feed dispensed. Additional details regarding a useful feed dispensing mechanism are illustrated and described in U.S. Pat. No. 6,269,770, which is hereby incorporated herein by reference in its entirety.

Referring to FIGS. 1-3, The feed pan 6 can form a trough running from end to end along each side of the animal feeder 2, which is disposed below and follows the length of the feed hopper 4. The feed pan 6 or trough can be generally elongated and rectangular in shape, and can be subdivided into feeding stations by dividers 36. The feed pan 6 and feed hopper 4 can share common end 10 walls as discussed above. Side walls 18 of the feed pan, where the animals access the feeder, are formed by a moveable member that can be in the form of a pan extension 20. The pan extension 20 can be supported and guided by a trough guide 22. The side wall 18 can also include a fixed feed pan wall 24 or member.

The trough guide 22 on each end of the animal feeder 2 receives an opposing end of the pan extension 20. The trough guide 22 can be a separate bracket from that of the fixed side wall 24 and the movable pan extension 20. Alternatively, the guide 22 can be an integral, one-piece part with either the fixed side wall 24 or the movable pan extension 20. As one example, the lateral ends of the fixed side wall 20 adjacent the feeder end walls 10 can be bent into generally U-shaped channels that function as the trough guide 22 at each end. As another example, the fixed side wall 24 can be bent to have a generally U-shaped cross-section transverse to its longitudinal axis, thereby forming a channel or trough guide 22 along its length. Thus, the movable pan extension 20 can be guided by the channel of the fixed side wall 24 in a telescoping manner. Of course, the opposite arrangement is also possible where the guide 22 is movable, for example, by forming the movable side wall 20 into a generally U-shaped channel along its length and having the movable side wall 20 ride along the fixed side wall 24 within the channel in a telescoping manner.

The trough guides 22 can be angled upwards and towards the direction the animal approaches the feed pan. Movement of the pan extension 20 can be guided by the trough guides 22. A fixed pan side wall 24 can be located below the movable pan extension 20. The pan extension 20 slides along the fixed feed pan wall 24 when the pan extension 20 is lowered. At the fully lowered position, the pan extension 20 can be substantially aligned with the feed pan wall 24. At the fully raised position, the pan extension 20 and the fixed side wall 24 cooperate to substantially double the effective height of the feed pan side wall; where the total height is substantially the sum of the fixed pan wall 24 height and the movable pan extension 20 height.

Because the trough guides 22 are angled upwards and towards the side where animals approach the feed pan 6, moving the pan extension 20 simultaneously changes both the vertical and horizontal dimensions of the feed pan 6. For example, as the pan extension 20 is lowered, sliding within the trough guide 22 in a downwardly and inwardly direction and along the feed pan wall 24, the access height to the feed pan 6 is lowered and the lateral dimension of the pan 6 is decreased. As such, a small animal or an animal with lower stature can reach over the top edge of the lowered pan extension 20 to access the bottom of feed pan 6. In addition, a small animal can reach further back into the feed pan 6. This also enables a smaller animal to reach any included actuating mechanism within the feeding area of the feed pan 6 as described hereinafter. This lowered position of the movable wall 20 is illustrated in FIG. 2.

Likewise, when the pan extension 20 is raised, siding within the trough guide 22 in an upward and outward direction and extending from the feed pan wall 24, the access height to the feed pan 6 is raised and the lateral distance to reach the opposite end of the feed pan 6 is increased. As such, a larger feed portion can be accommodated by the feed pan 6 for a larger animal and the raised pan extension 20 better resists feed spill from a larger animal using the feed pan 6. This reduces waste when a larger animal is using the animal feeder 2. In addition, the increased lateral dimension of the feed pan 6, increases the distance to any actuating mechanism within the feeder 2, thereby reducing the possibility of inadvertent actuation by a larger animal.

The pan extension 20 can be movable between its raised and lowered positions by turning a crank assembly 26 located at each corner at the top of the animal feeder 2. The crank assembly 26 can be connected to a trough adjustment rod assembly 28 that runs downward and connects to the pan extension 20. The crank assembly 26 can be connected to the trough adjustment rod 28 by a screw drive including cooperating threads, thereby raising or lowering the trough adjustment rod assembly 28 in the vertical direction. The trough adjustment rod assembly 28 can be physically connected at its other end to the pan extension 20 near the bottom of the animal feeder 2. The movement of the trough adjustment rod then moves the pan extension 20 within the trough guides 22, either raising the pan extension 20 in an upwardly and outwardly direction, or lowering the pan extension 20 in a downwardly and inwardly direction.

In the illustrated animal feeder 2, a crank handle of a crank assembly 26 and a corresponding adjustment rod assembly 28 can be associated with each end of each movable side wall member 20. Thus, each movable side wall member 20 can be moved between the raised position and the lowered position using the crank handles associated with its ends. Since separate adjustment mechanisms are used with each movable side wall 20, each movable side wall can be adjusted independently of the opposite movable side wall 20. Accordingly, one of the movable side walls 20 can be moved into its lowered position, while the opposite movable side wall is moved into its raised position. Thus, different groups of animals of different sizes can simultaneously use different sides of the feeder. Alternatively, a single adjustment mechanism linked to both of the movable side walls 20 can be provided so that both movable side walls are adjusted between the raised position and the lowered position together.

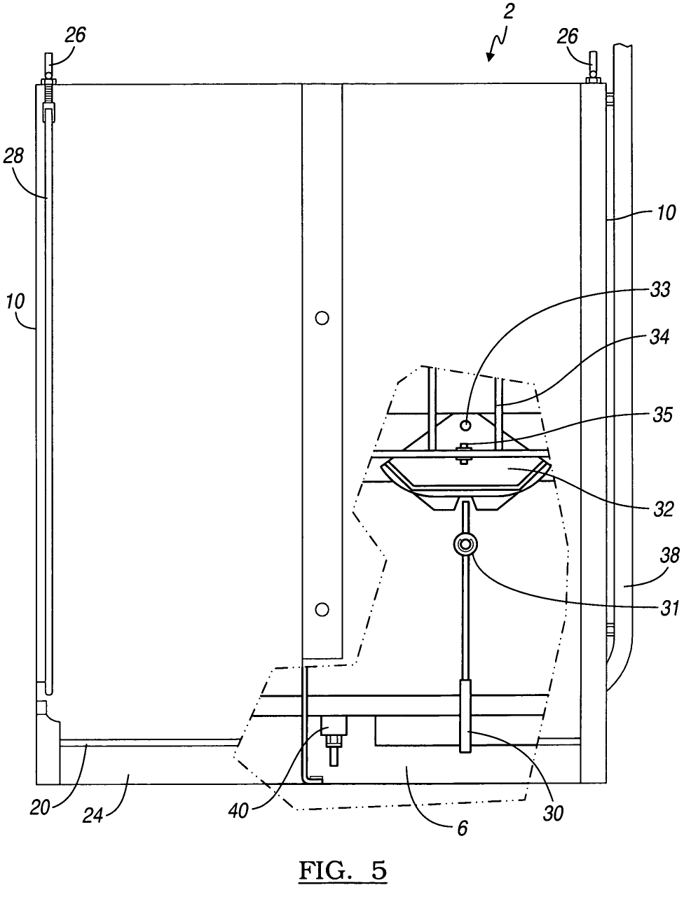

Referring to FIGS. 3-5, the feed pan 6 can include one end of a paddle assembly 30 or actuator located adjacent thereto so that it is in an animal feeding area. This end of the paddle assembly 30 can be actuated by an animal to transmit mechanical agitation through the paddle assembly 30. The mechanical agitation of the paddle assembly 30 causes it to pivot about a pivot 31. The paddle assembly 30 can be further operably connected to a bird assembly 32 or an oscillating member. The bird assembly 32 can be disposed adjacent the feed gate 8. In the illustrated embodiment, the bird assembly extends into the feed channel 15 at the throat of the downwardly converging bottom of the feed hopper 4.

Upon actuation by an animal, the pivoting paddle assembly 30, which can be operably connected to the bird assembly 32 causes the bird assembly 32 to pivot about its connection 33 to hopper wall 13. The paddle assembly 30 returns toward its original position, either under the weight of the paddle assembly 30 or in response to further actuation by an animal. Thus, the bird assembly 32 begins to move back toward its original position. Accordingly, the bird assembly 32 operates as an oscillating member that agitates any feed that is bridged, bound, or stuck in the area of the feed gate 8 adjacent the oscillating bird assembly 32 and will drop or flow into the feed pan 6. A shaker assembly 34 or a second oscillating member can be further pivotably attached to the bird assembly 32 via a pivoting connection 35 at one side thereof. In the illustrated embodiment, the shaker assembly 34 is a grid or grate shaped frame substantially spanning along one side wall 12 of the feed hopper 4. The shaker assembly 34 can pivot at the other side thereof at a pivot connection 37 to the feed hopper bottom 12. Thus, the shaker assembly 34 can be juxtaposed just above the surface of the feed hopper side wall 12. Thereby, the shaker assembly 34 can slide or rock from side-to-side across the bottom of the feed hopper 4. Feed that is bridged, bound, or stuck in this area of the feed hopper 4 can be shaken free by mechanical agitation caused by actuation of the paddle assembly 30, transmitted through the bird assembly 32, to the shaker assembly 34. Such agitator systems can be especially beneficial in humid climates where feed flow is more prone to be interrupted by feed sticking together or by binding in traveling between the hopper 4 and feed pan 6. An agitator system can also serve to ensure that an animal receives its entire feed portion. There can be more than one paddle assembly 30, bird assembly 32, and shaker assembly 34 in an animal feeder 2. For example, two are provided in the illustrated embodiment; one for each half of the feeder 2.

The animal feeder 2 can have dividers 36 separating the feed pan 6 into two or more areas to segregate animals while feeding. These dividers 36 provide privacy and partition the elongate feed pan 6 into multiple feeding stations. And the animal feeder 2 can thereby be used by multiple animals simultaneously. In the illustrated embodiment, the dividers 36 are formed of solid sheets or panels that extend from the feed hopper side walls, 12 or 13, to a bottom wall of the feed pan 6. It can be desirable that any openings in these dividers 36 be limited. Thus, privacy with respect to animals feeding at adjacent feeding stations can be facilitated. This can help insure animals are not distracted or disturbed while feeding which can increase weight gain.

The animal feeder 2 can also include a water tube assembly 38 and at least one nipple 40 to discharge water. The water tube assembly 38 can run vertically down one end 10 of the animal feeder 2 and can be connected to a water source located above the animal feeder 2. Near the bottom of the animal feeder 2, the water tube assembly 38 enters the animal feeder 2, running horizontally and longitudinally across the feed pan 6. One or more nipples 40 are located off of the horizontal portion of the water tube assembly 38 to dispense water into the feed pan 6. The nipple 40 can be automatically actuated, animal actuated, or actuated by an operator. In the illustrated embodiment, the nipple 40 can be of a type that can be actuated by an animal. The nipple 40 can discharge water directly into the feed pan 6, mixing water and feed, or can discharge water to a separate reservoir located inside the feed pan 6.

Many variations from the illustrated embodiment and description provided herein will be apparent to those skilled in the art. For example, although a four station, rectangular, hog feeder is disclosed herein any number of stations and configurations could be envisioned for feeding hogs or other animals. As another example, although each movable wall spans multiple feeding stations, a separate movable wall can be provided with respect to each feeding station. Of course, many additional modifications could be envisioned and it would be impossible to list all of them here. It should be understood, however, that nothing herein should be read exclude such variations.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. An animal feeder comprising:
a feed pan having a movable side wall that extends generally upwardly and over which an animal accesses feed in the feed pan, and the moveable side wall being moveable between a raised position and a lowered position.

2. The animal feeder of claim 1, wherein the generally upwardly extending side wall comprises a top edge, and the top edge moves upwardly and outwardly as the generally upwardly extending side wall moves from the lowered position to the raised position.

3. The animal feeder of claim 1, wherein the animal feeder comprises at least two generally movable side walls, wherein each of the movable side walls is movable independent of another movable side wall.

4. The animal feeder of claim 1, further comprising a fixed side wall member that cooperates with the movable side wall to define a combined side wall of the feed pan.

5. The animal feeder of claim 1, further comprising a guide supporting each end portion of the movable side wall, wherein the movable side wall slides along the guide as it moves between the raised position and the lowered position.

6. The animal feeder of claim 1, further comprising a connecting rod operably connecting the movable side wall to a crank handle via cooperating threaded members, wherein rotation of the crank handle operates to move the movable side wall.

7. An animal feeder comprising:
a. a feed hopper;
b. a feed pan comprising a moveable side wall defining an animal feed access opening and a pair of opposing end walls;
c. a guide adjacent each of the pair of opposing end walls, each guide supporting an opposing end portion of the moveable side wall for movement along the guides;
wherein the guides are angled with respect to a vertical orientation.

8. The animal feeder of claim 7, further comprising an adjustable feed gate between the feed hopper and the feed pan that controls the flow of feed from the feed hopper to the feed pan.

9. The animal feeder of claim 7, further comprising:
a. a paddle extending into a feed area that is capable of actuation by a feeding animal,
b. the paddle being linked to an oscillating member adjacent the feed gate,
wherein actuation of the paddle moves the oscillating member, thereby facilitating movement of feed from the feed hopper past the feed gate and into the feed pan.

10. The animal feeder of claim 9, further comprising:
a second oscillating member located along a side wall of the feed hopper, the second oscillating member being linked to the oscillating member so that the second oscillating member moves along with the oscillating member, thereby facilitating movement of feed within the feed hopper toward the feed gate.

11. The animal feeder of claim 7, further comprising a stationary side wall member along which the moveable member moves.

12. The animal feeder of claim 11, wherein the guide is an integral component of one of the movable side wall and the stationary side wall member.

13. The animal feeder of claim 9, further comprising:
a single moveable feed gate member, located at an upper end of a feed channel, along an angled side wall of the feed hopper, each end of the moveable feed gate being connected to an end of a rod, the opposite end of the rod being connected to a member that can be inserted into one of a plurality of adjustment openings.

14. An animal feeder comprising:
a. a feed hopper;
b. a feed pan located below the feed hopper to receive feed from the feed hopper, the feed pan including a fixed pan extension and a movable pan extension supported adjacent the fixed pan extension in a guide;
c. a crank assembly operably connected to the movable pan extension to move the movable pan extension along the guide to change a position of the movable pan extension in both a vertical dimension and a lateral dimension.

15. The animal feeder of claim 14, wherein the trough guide is angled upwards and toward the direction an animal approaches the feed pan, so that moving the movable pan extension simultaneously changes the access height to the feed pan and changes the horizontal approach distance for an animal to access the feed pan.

16. The animal feeder of claim 15, further comprising an animal actuation mechanism.

17. The animal feeder of claim 16 wherein the animal actuation mechanism is selected from one of a feed agitator mechanism and a water dispensing mechanism.

18. The animal feeder of claim 15, further comprising:
a. an adjustable feed gate between the feed hopper and the feed pan; and
b. a bird assembly adjacent the feed gate that is operably connected to a paddle assembly which extends to an area above the feed pan to permit oscillation of the bird assembly upon contact of the paddle assembly by an animal.

19. The animal feeder of claim 18, further comprising a shaker assembly extending into the feed hopper away from the feed gate, the shaker assembly being operably connected to the bird assembly to oscillate in response to oscillation of the bird assembly.

20. The animal feeder of claim 14, wherein the animal feeder comprises an additional movable pan extension supported in an additional guide, and wherein the additional movable pan extension is operably connected to an additional crank assembly to move the movable pan extension along the guide to change a position of the movable pan extension in both a vertical dimension and a lateral dimension.
